(19) United States
(12) Patent Application Publication
(10) Pub. No.: US 2017/0173853 A1
(43) Pub. Date: Jun. 22, 2017

(54) Integrally labeled, marked thermoplastic foam products, systems and methods

(71) Applicant: John Hart Miller, Aurora, CO (US)

(72) Inventor: John Hart Miller, Aurora, CO (US)

(21) Appl. No.: 15/530,157

(22) Filed: Dec. 7, 2016

Related U.S. Application Data
(60) Provisional application No. 62/386,997, filed on Dec. 17, 2015.

(51) Int. Cl. B29C 59/16; B29C 35/00; B29C 71/00; B28B 11/00; B41M 5/00; B28B 11/08; B41M 5/24; B41J 2/475; B41J 2/44; B29C 35/08; B29C 59/08

(52) U.S. Cl. CPC B29C 59/16; B29C 35/0805; B29C 35/002; B29C 71/0009; B28B 11/001; B29C 59/08; B28B 11/0872; B41M 5/24; B41J 2/475; B41J 2/442; B41M 5/0064; B29C 2035/0838; B29K 2101/12

(57) ABSTRACT

Foam products of a material having many voids or gas bubbles therein are marked by one or more of a plurality of devices capable of melting and/or vaporizing a desired pattern into a surface portion of the foam product, at least some doing so by movement of a hot tool, laser, flame, hot gas or other hot item, and systems and methods for making the mark or marks forming the desired pattern are disclosed along with the so marked foam products

This application claims the benefit of the filing date of Provisional Patent Application No. 62/386,997 filed on Dec. 17, 2015.

The present invention includes labeled or marked thermoplastic foam items, systems and methods for marking thermoplastic foam items, including polymer and resin foams, inorganic foams like glass and ceramic and metal foam products, with special grooves forming letters, numbers, logos, symbols, and other desired images, including optionally filling some or all of the grooves with a contrasting material.

### BACKGROUND

Thermoplastic foam products can be labeled or marked while molding, but if made from non-label molded products, such as foam board and many other products, they present a problem with marking the product with a trade-name, trademark, logo, address, patent notice, etc. Most adhesives, paint and the like will not adhere permanently to the surface of the foam product, usually not at all. While some adhesives have been proposed for adhering labels to polymer foam, these are expensive and can present hazards when the labels are peeled off by young children. Thus, it has been necessary to either foam the polymer against a mold containing the desired marking, in which the formed part often sticks in the small indents or raised places on the mold, or the use of a costly, difficult adhering process like that disclosed in Pub. Pat. Application No. 20030068470, and one or more patents having a similar approach. There is a long felt and very substantial need to mark thermoplastic foam products, and other foam products like cryogenic insulation, etc., in a permanent, durable, relatively inexpensive and attractive manner.

### SUMMARY

The invention comprises systems and methods for marking, applying one or more of visible letters (in any language including picture words or letters like Kanji, Arabic, and the like), numbers, numerals, symbols, logos, drawings, and other desired images into the surface portion of a meltable and/or thermoplastic materials and products, including polymers, resins, sugars, candies, and low melting point metals having a void or gas pocket content in the surface portion to be marked of at least about 5 or 10 or 15 or 20 or 25 or 30 percent by weight or any percent in between these numbers, and can have 3 percent by volume up to 95 percent by volume or any percent in between these numbers, and products so marked. The marks include grooves, valleys or holes or the like having a depth of at least about 0.01 or 0.02 inch but preferably a greater depth. The depth of the mark often depends to some extent upon the size of the product being marked. Often the void, or gas bubble, content of the material or product to be marked will often exceed about 10 volume percent such as to include any incremental amount of about 5 or 10-99 percent based on the density of the base material, preferably from about 15 to about 90 volume percent and most preferably about 20 to about 90 volume percent. As a further marking step, the grooves, valleys and/or holes can be coated, partially filled, completely filled or slightly over filled to with a material that will set up to form solid material, preferably one that is of a contrasting color and/or at least as flexible as the material or product. Some of these foam items can have densities of 0.01-1 gm/cc and lower, and much higher in other items, particularly metal, glass and ceramics. Typically, polymer foam items have densities higher than 0.1 gm/cc, often in the range of 0.01-2 gm/cc.

The present invention includes methods of marking the above described materials including thermoplastic foam items or products, such as placing a logo, trade-name, trademark, patent notice, or other desired letters, numbers and the like into thermoplastic foam parts while leaving surrounding areas of the surface of the foam in a shape that is not unattractive to consumers and that does not negatively affect the use of the product by bringing an item close to the surface of the material or product, the item being sufficiently hot to melt the material or product surface portion in the vicinity of the item to a depth of at least about 0.03 inch (while the hot item can include many things, those preferred include a hot branding tool, a hot focused flame, a hot wire or rod, a hot energy beam and a hot stream of gas of a desired small diameter). These methods comprise the following different techniques:

1) a method of marking a surface portion of a thermoplastic foam item comprising heating a branding iron having the shape of the desired label comprising shapes comprising letters, numbers, logo(s) and the like with each having specially shaped sides including tapered and/or L shaped, heating at least the contacting ends of said shapes to a temperature significantly higher than the melting point of the thermoplastic foam and applying the hot contact ends of said shapes to a surface of the thermoplastic foam allowing said contact ends to melt into the thermoplastic foam a desired distance and removing said contact ends from said thermoplastic foam a distance to prevent any further deformation of the thermoplastic foam, or

2) a method comprising moving a very hot wire or small rod or other suitable shape while very close to the surface of the foam item, or at times below the surface, in a manner to melt the foam that is close to the very hot wire or rod to form one or more grooves forming the desired marking, or

3) a method comprising moving one or more laser beams of the appropriate type and intensity to melt form one or more grooves in a foam item forming the desired foam item, and

4) optionally, adding paint or a coloring or material of contrasting color to at least a portion of the one or more grooves formed by the methods of 1 and/or 2 and/or 3 above.

5) a method comprising heating a thermoplastic coloring material to produce a hot liquid having a temperature that will cause a thermoplastic foam to collapse beneath an applied stream of the hot liquid placed on a surface of the thermoplastic foam item, applying a stream of said hot liquid to the surface of the thermoplastic foam item in a desired pattern, allowing said applied stream to recede into the foam while leaving the immediate surrounding foam relatively unaffected to the eyes of an observer thus leaving a pattern of contrasting color in the thermoplastic foam item. Optionally, the thermoplastic coloring material can be of a composition that it will expand slightly following application such that when cooled and solidified it will be even more tightly attached to the thermoplastic foam item. The stream can be applied by mounting a heated pot containing the hot liquid and having an outlet with a controllable valve, etc. onto an XYZ positioner and programming the movement of said pot and the opening and closing of said controllable valve to apply the hot liquid in the desired pattern.

6) an optional step comprising using an X Y positioner, or an X Y Z positioner to move the various apparatus used to practice the methods set out in the methods of methods 1-5 set out above and programming said positioner and said apparatus with on and off control and optionally other control to melt a desired pattern onto and into the surface portion of a thermoplastic foam item to one or more desired depths. Optionally, the pattern can then be at least partially filled with a material of contrasting color, optionally an elastomer material and optionally a material that will expand some during curing to even more firmly grip the interior of the pattern. Also optionally, materials of different colors can be applied to different parts of said pattern in the same manner and with the same optional features.

The invention also includes systems, combinations of apparatus used in the methods described above including one or more of the following:

1) a branding iron having tapered sides on one or more sides of patterns to form the desired label, mark, or having an inverted T shaped continuous or discontinuous branding iron that when it melts the foam directly under the brand will form a desired grooved pattern, a device to heat the branding iron quickly to the desired temperature desired for branding and a mechanism for moving the branding iron first to the heating device, then to the proper position for forming the one or more grooved pattern(s) and then back to the heating device,

2) an X-Y positioning device or an X-Y-Z positioning device holding a tube, a gas source and the tube connected to a gas source, the tube being heated to a temperature sufficient to melt thermoplastic foams, a heater for heating the gas while moving through the tube and a programmable device for guiding the X Y positioning device or X Y Z positioning device to locate an end of the tube close to the surface of the thermoplastic foam and to move the tube in a path and at a rate for producing a desired grooved label,

3) an X Y positioning device or an X Y Z positioning device holding a wire or rod that can be heated, preferably with electrical resistance, to a temperature sufficient to melt thermoplastic foams, an apparatus for heating the wire or rod and a programmable device for guiding the X Y positioning device or X Y Z positioning device to locate an end of the wire or rod close to the surface of the thermoplastic foam and to move the tube in a path and at a rate for producing a desired grooved label,

4) an X Y positioning device or an X Y Z positioning device holding a flame source and a flame having a temperature sufficient to melt TPPFP including thermoplastic foams and a programmable device for guiding the X Y positioning device or X Y Z positioning device to locate an end of the tube close to the surface of the thermoplastic foam and to move the tube in a path and at a rate for producing a desired grooved label,

5) an X Y positioning device or an X Y Z positioning device holding a laser and directing a laser beam of a temperature sufficient to melt a thermoplastic foam, and a programmable device for guiding the X Y positioning device or X Y Z positioning device to move the laser beam in a path, at the desired intensity or percentage of the laser's power, and at a rate for producing a desired grooved label,

6) an X Y positioning device or an X Y Z positioning device holding a container of coloring or colored material and for activating and deactivating an orifice in or on the container to release a small stream of the contents and a programmable device for guiding the X Y positioning device or X Y Z positioning device to move the container in a path and at a rate, while activating and deactivating the orifice for producing a desired color in the grooved label, alone or in combination with any of (1) through (5) above, and

7) an X Y positioning device or an X Y Z positioning device holding a container of hot, molten coloring or colored material and a mechanical or hydraulic activating and deactivating device on an orifice in or on the container to release a small stream of the contents, a heater for keeping the container hot, the temperature of said material being sufficient to melt a groove in a thermoplastic foam a desired depth, and a programmable device for guiding the X Y positioning device or X Y Z positioning device to move the container in a path and at a rate, while activating and deactivating the orifice for producing a desired pattern in the thermoplastic foam item. The size of the stream, the temperature of the stream and the heat capacity and coefficient of thermal conductivity of the material in the stream determine the width and depth of the marking, alone or in combination with any of (1) through (5) above, and

8) a laser emitting tube arranged with an X-Y positioning device, or an X-Y-Z positioning device directing the laser beam of an intensity and duration sufficient to melt or deform a thermoplastic or meltable foam, and a programmable device for guiding the X-Y or X-Y-Z positioning device to move the laser beam in a path, at the desired intensity or percentage of the laser's power, and at a rate for producing the desired marked, grooved mark or label,

9) one or more lasers with or without one or more Z positioners, i.e. for moving up and down, for the laser(s) with one or more mirrors, preferably one or more movable mirrors, to change the laser beam(s) and to rapidly direct them to produce the desired mark in a more rapid manner than that produced by system (8) just above,

10) an ink jet printer, or equivalent printer, in combination with the laser systems of either (8) or (9) above such that following the laser(s) making the desired mark, the printer then afterwards prints a contrasting color into all or part(s) the mark,

11) an ink jet printer, laser printer or any known (at the time of use) and suitable printer, in combination with the laser systems of either (8) or (9) such that the ink jet printer first prints the mark, or part(s) of the mark onto the foam product, followed by the laser(s) melting the ink alone or the ink and foam just below the mark, both locking the ink mark into the foam,

12) a device (many are known) to move a particle dispenser to lay a thin layer of particles of contrasting material (color, texture, or the like) on the surface of the foam product covering at least a part of the mark and a laser system described in (8) or (9) above to heat at least the particles in at least a portion of the mark to cause the particles to either melt or to melt the foam just below the particles such as to lock the particle melt or particles into the foam, optionally forming the rest of the mark in the area(s) of the desired mark not covered with said particles.

Finally, the invention includes the marked products made by the methods and systems described above.

The marked products, systems and methods disclosed herein have marks made by melting one or more grooves or holes or other shaped depressions in TPPTP products or products made from meltable foam materials. One or more of the systems and methods results in a product in which a hot melt, preferably of a contrasting color to the foam product, forms the grooves or holes and at least partially fills the groove(s) and/or hole(s). While often the foam product will be a resin or polymer, the foam product can also be inorganic materials like foamed glass, foamed metal, foamed alloy and foamed ceramic items including foamed hydraulic set items like foamed cement, foamed plaster of Paris, foamed concrete and similar foamed items. Some of the thermoplastic and meltable polymer foam items include items made using polyethylene, polypropylene, polystyrene, polyurethane, elastomers, urea formaldehyde, polycarbonate, ABS, PPO, PVOH, PVC, nylon, acrylic, polyester, and other meltable organic foam materials.

Other embodiments involve painting or at least partially filling the one or more holes and/or grooves with a material, preferably of a contrasting color to the foam product, that dries or sets up to form a flexible material bonded to or locked in to said hole(s) and/or groove(s). The depth of the grooves, holes, or other shaped depressions are really a matter of choice to provide the desired visibility, but typically can vary from just enough to easily see the mark to from about 0.03 (0.76 mm) to as deep as desired, usually less than 0.5 (12.7 mm) inch and often less than 0.3 inch (7.6 mm), however, the one or more hole(s) and/or groove(s) can penetrate the entire thickness of the foam product when desired, and should be deep enough that one can readily see the mark.

Herein, when a range of number values is disclosed it is to be understood by those of ordinary skill in the appropriate art(s) that each numerical value in between the upper limit and the lower limit of the range is also disclosed, to at least 0.01 of a full number. Thus in a range of 1 to 10, this includes 2.04 to 10, 3.06 to 8 or 8.50, and so on. The addition of a new limitation in a claim previously stating from 2 to 7 changing it to from 3-7 or 4-6 would not introduce new matter whether those new ranges were specifically disclosed in the specification or not because of this explanation of the meaning of a disclosed broader range, such as 1-10. This meaning of a range is in keeping with the requirement in 35 USC 112 that the disclosure be concise.

Further, when the word “about” is used herein it is meant that the amount or condition it modifies can vary some beyond that stated so long as the advantages of the invention are realized. Practically, there is rarely the time or resources available to very precisely determine the limits of all the parameters of one's invention because to do so would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors' disclosure and understanding the inventive concept and embodiments disclosed including the best mode known to the inventor, the inventor and others can, without inventive effort, explore beyond the limits disclosed to determine if the invention is realized beyond those limits and, when embodiments are found to be without any unexpected characteristics, those embodiments are within the meaning of the term “about” as used herein. It is not difficult for the artisan or others to determine whether such an embodiment is either as expected or, because of either a break in the continuity of results or one or more features that are significantly better than reported by the inventor, is surprising and thus an unobvious teaching leading to a further advance in the art.

### BRIEF DESCRIPTION OF THE DRAWINGS

FIG. 1 is a plan view of a thermoplastic foam board product having a grooved label made with a hot branding tool (hot tapered rod) according to the invention.

FIG. 1A is a plan view of the thermoplastic foam board product having a grooved mark made with a hot branding tool of FIGS. 2 and 3 photographs, according to the invention.

FIG. 1B is a plan view of a thermoplastic foam board having a grooved logo mark made with a hot copper cookie cutter type branding tool according to the invention.

FIG. 2 is a plan view of the branding tool used to make the branded thermoplastic foam item of FIG. 1A.

FIG. 2A is a perspective view of a star shaped cookie cutter type branding tool used to form the mark shown in FIG. 1B.

FIG. 3 is a front view of the branding tool of FIG. 2 used to form the mark shown in FIG. 1A.

FIG. 4 is a cross sectional view of one of the numbers on the branding tool of FIGS. 2 and 3.

FIG. 4A is a cross sectional view of one of the numbers or letters on a different branding tool having most mass located where the most melting will take place.

FIG. 4B is a cross sectional view of one of the numbers or letters on an even different branding tool having most mass located where the most melting will take place for making shallow grooves.

FIG. 4C is a cross sectional view of one of the numbers or letters on a still different branding tool having most mass located where the most melting will take place for making deeper grooves.

FIG. 4D is a front view of a sub-system for one way of mounting, manipulating and heating the branding tools of FIGS. 4, 4A, 4B, 4C and others for marking according to the invention.

FIG. 4E is a front view of a mounting, manipulating and heating system similar to the system shown in FIG. 4D, and like the system of 4D, can also be used to move hot wire(s), rod(s) etc. to mark a foam product.

FIG. 4F is a side view of the mounting, manipulating and heating system of FIG. 4E and is similar to what a side view of FIG. 4D would also look like.

FIG. 5 is a plan view of a thermoplastic foam board like that of FIG. 1 having a grooved label with some of the grooves filled with materials of contrasting colors according to the invention.

FIG. 5A is a plan view of a thermoplastic foam board having groove number and letter marks made by a method described below using a hot wire and with the number one and two holes, dots partially filled with a material of a contrasting color.

FIG. 6 is a plan view of a thermoplastic foam board product having a label formed by the application of a small stream of a hot liquid material of a contrasting color to form embedded and locked-in letters that protrude above the surface somewhat.

FIG. 6A is a front cross-sectional view of an apparatus used to make the label on the thermoplastic foam item of FIG. 6.

FIG. 6B is a front view of an apparatus like or similar to the apparatus of FIG. 6A also having a marking tool mounted to proceed the path of the FIG. 6 apparatus.

FIG. 7, is a plan view of a thermoplastic foam board having a mark made by a hot marking tool like that shown in FIG. 7A.

FIG. 7A is a partial front view of one of many suitable hot marking tools kept at the proper temperature by a torch.

FIG. 7B is a partial front view of a tip of an electric soldering iron marking tool.

FIG. 7C is a partial front view of a marking tool that uses a hot air/gas stream as the marking tool.

FIG. 7D is a partial front view of a marking tool that uses a controlled hot flame as the marking tool.

FIG. 8 is a plan view of a thermoplastic foam board marked with letters and numbers using a laser beam and a positioner.

FIG. 8A is a plan view of a thermoplastic foam board also marked with letters and numbers using a moving laser beam.

FIG. 8B is a plan view of a thermoplastic foam board marked with a logo using a laser and an X-Y-Z positioner.

### DETAILED DESCRIPTION OF SOME EMBODIMENTS AND BEST MODE

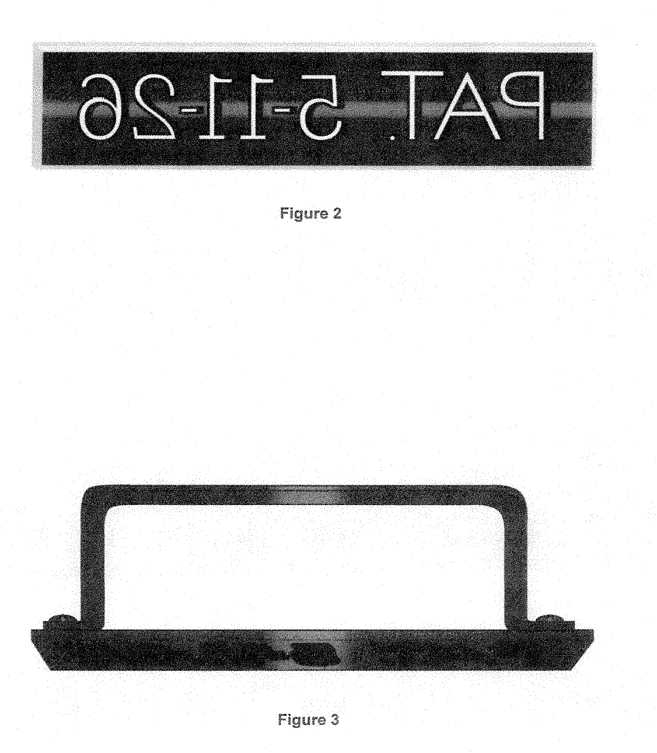

The first method comprises using a branding tool, such as that shown in photos labeled FIGS. 2 and 3 with the marking portion of the tool heated to an appropriate temperature to melt the thermoplastic polymer foam product (TPPFP) to form the desired marking in the TPPFP. The branding tool can be made of cast iron, stainless steel alloy or other high temperature metal or alloy to mark a foam glass product, such as a foam glass cryogenic insulation product. Other examples of suitable branding tools include cookie cutters, particularly those made of copper, stainless steel, tin and other metals and alloys. A preferred form of cookie cutter brand is one where the lower portion of the branding tool is a double thickness, such as made by folding over the lower portion of the branding iron to form two layers, like sometimes the top portion of actual cookie cutters are made to provide more rigidity to hold the shape. Preferably, the temperature of at least a surface portion of the branding tool is hot enough to melt the TPPFP without actually contacting the foam eliminating any buildup of the polymer on the surface of the branding tool. Also, preferably, the branding portion of the branding tool, such as that shown in FIGS. 2 and 3 is made of a metal having a high coefficient of thermal conductivity and a high heat capacity, in some cases may be heated directly or is heated indirectly with electricity, but not limited to, copper, silver and at least some alloys containing these or similar metals with respect to the characteristics mentioned above. The letters and numbers on the branding tool of FIGS. 2 and 3 are melt cast copper, but can be formed in any manner such as by machining, stamping, powder metallurgy, 3D forming using a laser, and other methods of forming metals and alloys.

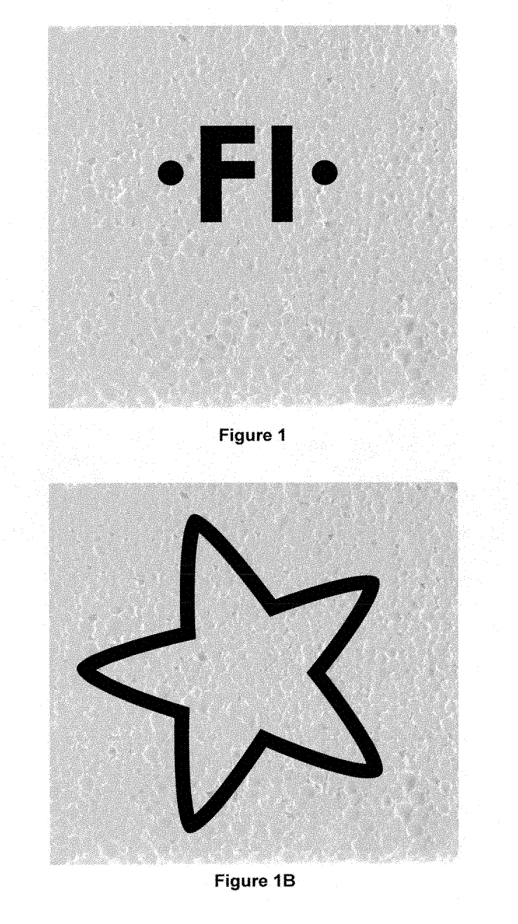

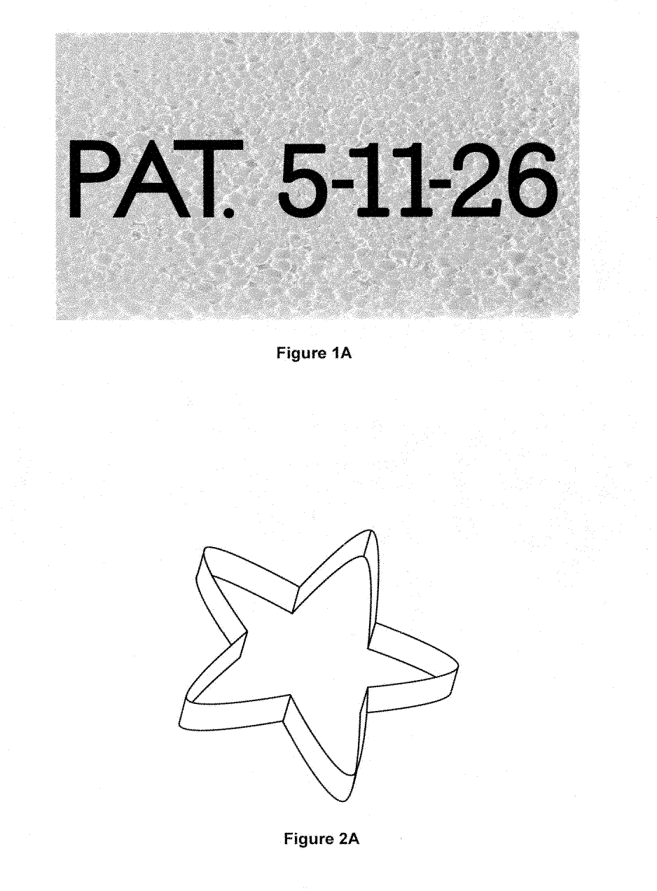

FIG. 1 is a plan view photograph of a black thermoplastic foam (TPPFP) board about 1 inch thick of polyurethane foam having a density of at least about 0.1 gm/cc or at least about 6 PCF having two dot depressions and the letter F and the number one made with a hot tapered rod as described below. FIG. 1A is a plan view photograph of the thermoplastic foam board product, like that of FIG. 1, having a grooved mark also made with a hot branding tool of FIGS. 2 and 3, according to the invention. FIG. 1B is a plan view of a thermoplastic foam board having a grooved star shaped logo mark made with a hot cookie cutter type branding tool according to the invention, the cookie cutter branding tool being made of copper is shown in perspective view in FIG. 2A.

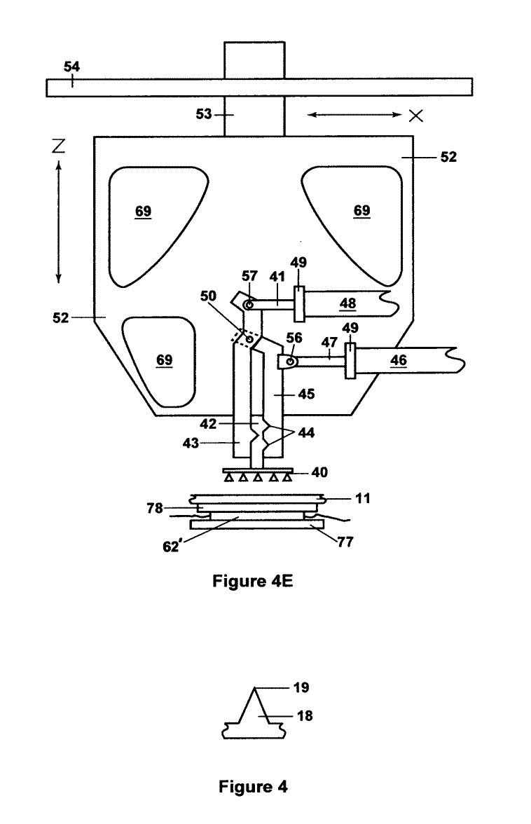

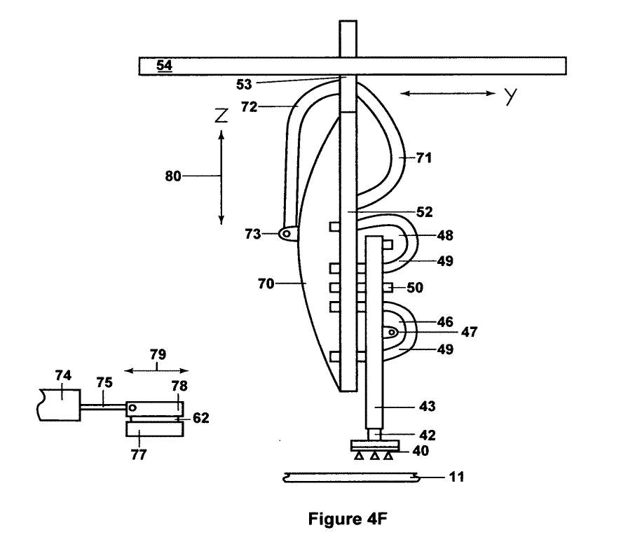

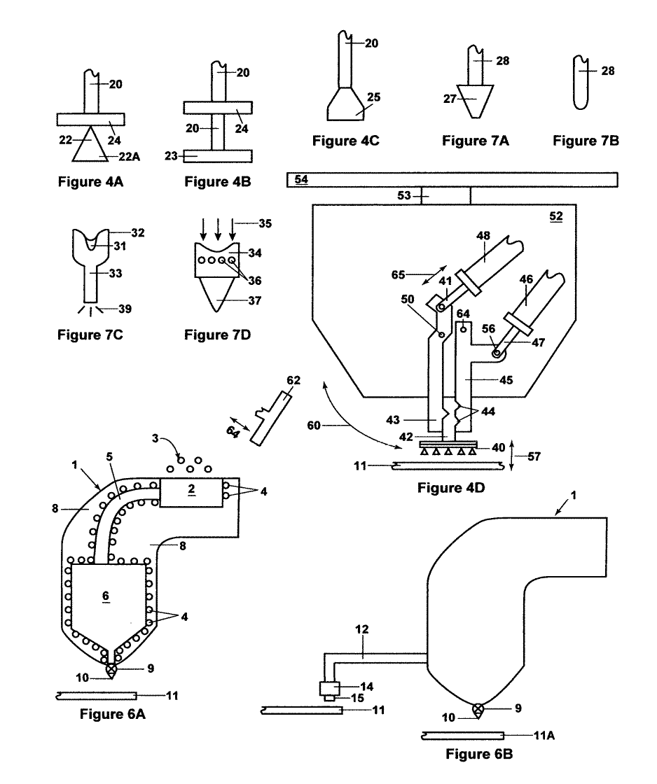

FIG. 4 is a partial cross section view of a marking portion of the branding tool shown in FIGS. 2 and 3 and shows a cross section of one of the letters. Note that in this tool, the base 18 of the letters and numbers is more massive and wider than the top 19 of the number or letter, but It is preferable that the letters, numbers, symbols, etc. of the branding tool be shaped or tapered such that the hot surface having the greatest mass is closest to where it is desired to do the most work in melting the foam, or the TPPFP. Three of many possible such letter, number, logo, etc. shapes are shown in cross-section in FIGS. 4A, 4B and 4C. In FIG. 4A the branding letter, number, etc. 22 is shaped so the most mass is at the lowest part 22A of the tool since it will need to contain the most heat energy to do the most melting. An optional shield 24 is part of the tool to reflect any heat back down towards the lowest part 22-22A of the tool. An upper stem 20 is for gripping, usually by a known mechanical or hydraulic gripping device (not shown, but many types are well known) for holding the branding tool while being moved by hand or by any known positioning device like an X-Y or an X-Y-Z positioning device like those mentioned later. The branding tool shown in FIG. 4B is for making a mark of a small depth and thus the mass of the lowest part 23 is smaller as it will do less work. The branding tool shown in FIG. 4C is another way of shaping the lowest part 25 to contain the most heat energy where the most melting work takes place. All of these branding tools have a stem 20 for gripping by a device for precisely moving the branding tool down to the surface, and optionally into, the product to be marked and then withdrawing the branding tool.

FIG. 4D shows, in a front view, one system of mechanically or hydraulically gripping a branding tool like those described above and others for heating, moving and marking a foam product according to the invention. This system is a totally automated, operated in any desired manner depending upon the nature of the product 11 being marked and the type of mark being applied. This system comprises a branding tool 40 of the types previously described in FIGS. 2, 3, 4, 4A, 4B, 4C, or branding tools so described above, having a stem 42 with some kind of holding shape like the projections 44, and/or one or more indents opposite the projections 44, for gripping by gripping members 43 and 45 that are manipulated by either mechanical or hydraulic devices 46,48 that can be fluid (a gas or liquid) operated cylinders or mechanical such as linear actuators or other means of physically moving gripper members 43,45 to grip and hold the stem 42 to apply the branding tool 40 to mark a foam product 11. The gripping member 43 is rotationally supported on a pivot axle 50 that is attached to the frame 52. A rod 41 of a cylinder 48, attached to the frame 52, is attached to the upper end portion of the gripping member 43. The cylinder 48 by extending its rod 41 in and out moves the gripping end of the gripping member 43 into and out of engagement with the stem 42 as shown by the arrow 65 and, if necessary, pushes the stem 42 into engagement with the other gripping member 45. The gripping member 45 is rotationally supported by a rod 64 attached to the frame 52, or can alternatively be supported by a back piece (not shown) that is also rotationally attached to the back side of the pivot rod 50 and held in the desired position by rod 47 attached in a rotationally manner by a clevis and bolt through a lug 56 actuated by cylinder 46. The cylinder 46 is also attached to the frame 52. The frame 52 is mounted to a Z actuator 53 for (vertical movement up and down as shown by arrows 57 on an X-Y-Z positioner 54 and the frame 52 preferably supports everything involved with manipulating the branding tool 40. The other gripping member 45 is rotationally supported on the rod 50 and has a lug 56 extending on one side for rotatable attachment of a rod 47 extending from the cylinder 46 for moving the branding tool 40 in an arc as shown by the arrow 60 to lift the tool 40 into a close proximity or into actual contact with a hot plate 62 that can heat the branding tool 40 to the desired temperature between one or more marking steps. As shown here, the hot plate 62 is electrically heated in a known manner, but can be heated with a surface combustion burner, a torch or torches or any other suitable manner. The branding tool 40 is moved to and from the hot plate 62 by coordinated movement of the rods 41 and 47 of the cylinders or actuators 48 and 46 respectively working in coordination. Optionally, the hot plate 62 can also be manipulated in a known manner, see arrow 64, to enhance heating of the branding tool 40 if desired. It will be within the ordinary skill of the art to make other known arrangements for moving the branding tool 40 in the manner described above or an equivalent manner with the location of the branding tool heater 62 being flexible.

FIG. 4E is a front view of a system for mounting, manipulating and, optionally heating a branding tool, or a heated wire, rod, hot gas tube, laser or other. The system in FIG. 4E is similar to the system in FIG. 4D with some modifications of the location of the hot plate 62, see 62′. The same elements located in the same place use the same numbers, additional elements use new numbers and the same, but relocated elements use a prime mark after the number. This system also uses an X-Y-Z positioner 54, to mount and manipulate the branding tool 40. The Z moving element, 53 is attached to the frame 52 on which is mounted numerous elements and can have one or more optional openings 69 to lightening the weight of the frame 52. The branding tool 40 has a stem 42 for gripping by two grippers 43 and 45, both of which is rotationally mounted on the frame 52 by bolt 50. The grippers 43,45 are pivoted around the mounting bolt 50 with fluid cylinders, electrical linear actuators, or equivalent 48,46 respectively by the movement in and out of rods 41,47 respectively, rod 41 attached to an upper end of gripper 43 with a pin and clevis 57 and rod 47 attached to a lug 56 on gripper 45. The cylinders, etc. 48,46 are mounted to the frame 52 with brackets 49 that allow the cylinders 48,46 to pivot at that location to permit X and/or Z movement of the end of the rods 41,47. Behind, and at a lower level than the branding tool 40, is a hot plate 62′ for reheating the branding tool when needed, preferably by an electrical resistant hot plate, but a surface combustion burner, torch(es) and/or equivalent heater(s) could be used instead.

FIG. 4F is a side view of the system of FIG. 4E. Additional items are one or more optional frame stiffeners 70 and one or more optional frame supports 71,72 with support 72 being optionally attached to one or more optional frame stiffeners 70 with an optional lug and pin 73 allowing the support(s) 72 to be unfastened. This view shows how the branding tool 40 can be, when it is desired to reheat the branding tool 40, moved, in this case along the Y axis, to the hot plate 62. Prior to the branding tool 40 arriving above the hot plate 62, a third fluid cylinder, linear actuator, etc. 74 moves a rod 75 attached to an insulation piece 78 back away from the hot plate 62, see arrows 79, so the branding tool 40 can be lowered onto the hot plate 62 by the Z positioner, see arrows 80. The insulation piece 77 below the hot plate 62 need not be moved. Suitable insulation for pieces 77,78 can be a 1600 degrees F. type insulating fire brick/slab, a slab of inorganic bonded fiber glass or ceramic fiber insulation of known types.

The branding tools can be heated to a temperature that will melt or at least melt the foam product being marked by any suitable manner such as with a torch, hot air, electrical resistance, etc. Another way to heat the branding tool is to set it, letters, numbers etc. against a hot surface of a hot plate 62 as shown in FIG. 4D prior to branding one or more TPPFP's. One marking made in the manner described broadly in this paragraph is shown in plan view in FIG. 1A and a logo mark made with a cookie cutter type branding iron is seen in plan view in FIG. 1B. The hot plate, preferably electrically heated to a controlled temperature, can be mounted on an X-Y or X-Y-Z positioner close to where the branding tool is located, the hot plate and/or the branding tool being so held in such a manner that when needed, the marking letters, numbers, logo, etc. of the branding tool can be placed in contact with the hot surface of the hot plate to bring the temperature of the letters, numbers, logo, etc. up to the desired temperature. Where an X-Y or X-Y-Z positioner is not used, the branding tool, when not in use branding a product, can be placed with the numbers, letters, logo, etc. against a hot plate until it is ready to brand a TPPFP product. This in an automated system is shown in FIG. 4D. When only an X-Y positioner is used, the product to be branded is mounted on a device that can lift the product to be marked upward into engagement with the branding tool 40, then lowered and then the X-Y positioner can move the branding tool to a position where the branding tool 40 is just above a hot plate or other branding tool 40 heater like the hot plate 62. In this embodiment a robot or a person can remove the marked product and place a product to be marked in the proper position.

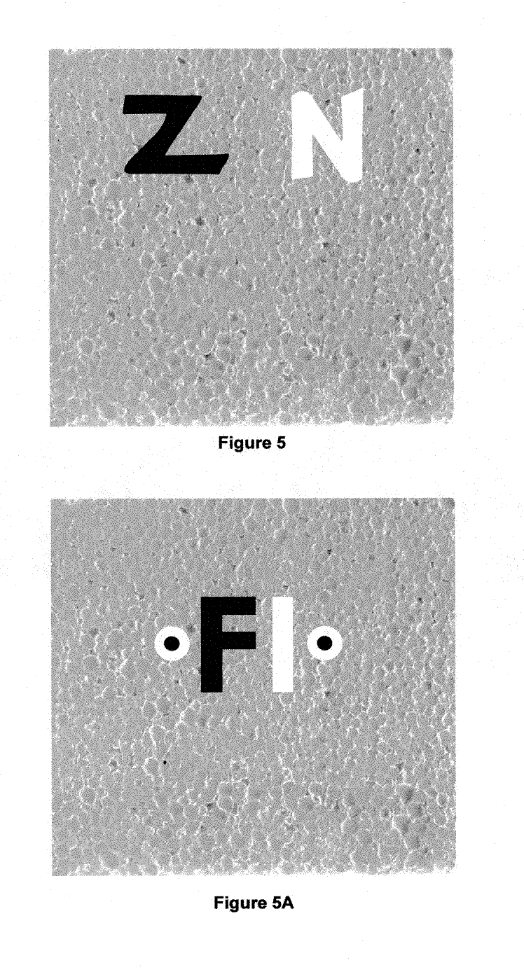

A modification of the method just described is to add another step of either painting a portion or all of the interior surface(s) of the marking(s) in the TPPFP, or partially or completely filling or over filling them with a liquid or paste or caulk of a desired color that will set up to form a durable contrasting material, preferably a flexible material, making the marking more readily seen and more impressive. Some examples of suitable materials are commercial latex paints, silicon rubber, caulking products, caulking material for concrete, especially for swimming pools and walks, etc. surrounding swimming pools. Due to some unevenness of the surfaces of the groove(s) the paint or filling material will be locked into the groove(s). The groove filling material can be made more colorful if desired by blending in one or more appropriate pigments or colorants that will not interfere with the setting up and/or durability of the groove filling material. An example of a TPPFP, foam board, partly marked by this technique is shown in FIG. 5 with one letter partially filled with a yellow paint and another letter partially filled with a white paint. The grooves in FIG. 5 vary in depth from 0.07 inch up to 0.25 inch (1.8 to 6.35 mm). FIG. 5A is plan view of a thermoplastic foam board having grooved marks made by a method described below using a hot wire with some of the grooves filled with a white caulk material.

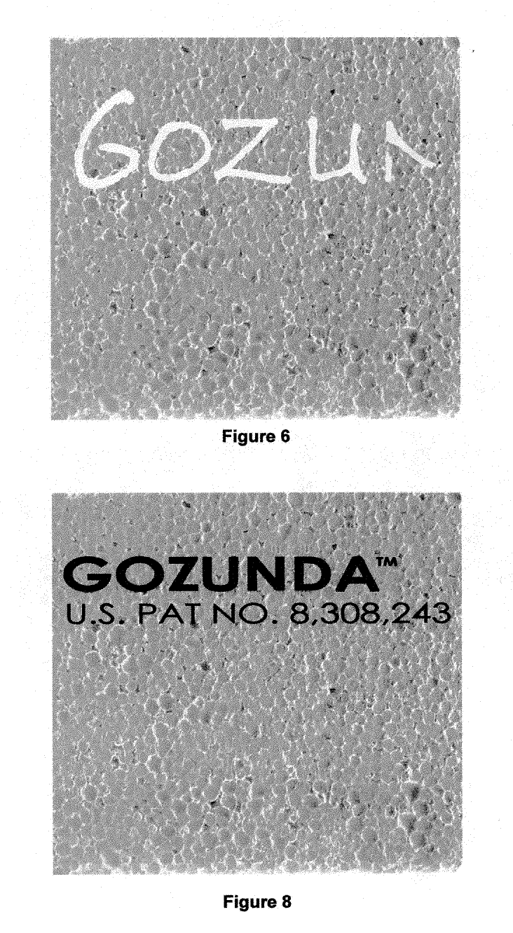

FIG. 6 is a plan view of a TPPFP marked using a method of the invention comprising applying a hot stream of material that is hot enough to melt the TPPFP to a desired depth and that upon cooling will set up to form a contrasting color marking locked into the TPPFP. This is accomplished with a small stream of material, such as a colored, preferably brightly colored, thermoplastic polymer, wax, or other meltable material like glass, ceramic, metal or alloy preheated to a temperature that will melt the foam product to a desired depth without spreading very much to leave a distinct mark at least partially sunken into, and fused to, the thermoplastic foam or other meltable foam. It is preferable to use a TP polymer that remains fairly viscous at the required temperature for melting the TP foam, but a moving extruder or dispensing tool laying down a stream of the hot liquid can optionally have a guide or sides that keep the hot stream in a desired width until it sinks down below the foam surface. It is preferable that the top surface of the hot stream label is just slightly above, even or somewhat below the surface of the foam when the temperature of the hot stream cools to a temperature below the melting temperature of the foam.

FIG. 6A is a front cross sectional view of one type of vessel 1 that can be used to mark a TPPFP or other meltable product like that just described and shown in FIG. 6. The vessel 1 can be of any reasonable shape and size with cross-sections of a circle, oval, square, rectangular or other and can be mounted on an X-Y or X-Y-Z positioner, like 53/54 in FIG. 4D. The positioner is programmed to move the vessel 1 in a manner to produce the desired mark on the foam product 11. The vessel 1 is comprised of a receptor 2, can be any reasonable shape, but preferably is a narrow oval for more rapid heating of the center portion and ease of cleaning, with a channel 5 connected thereto and to a container 6, can be any reasonable shape, but preferably is a narrow oval for the same reasons, having a valve 9 and a nozzle 10. The receptor 2 is heated by heating coils 4 to receive a hot liquid or particles or pieces 3 to melt, which melt flows through the channel 5, that can also be heated to appropriate temperature with heating coils 4, delivering the hot melt into the container 6, also heated by heating coils 4, to deliver the hot melt, at the proper temperature to make the desired mark, to the nozzle 10 when the valve 9 is opened, and then later closed by the program controlling the movement of the vessel 1, preferably by the X-Y or the X-Y-Z positioner (not shown) or by some robotic device. The heating coils 4 are activated and controlled to heat at the appropriate temperature with a separate electrical controller of known types and in a well-known manner. In the instances where the hot liquid is a melt of glass, metal, alloy, or ceramic, the receptor, channel, container valve and nozzle are made of a metal, metal alloy or ceramic material suitable and known for containment of the hot melt, and the heating coils and insulation are selected for the temperature required for the hot melt. For example, copper and stainless steel are suitable for polymers and wax, and refractory metals and precious metals like platinum or platinum rhodium alloys are suitable for glass, and various refractory metals and inorganic refractory materials are suitable for molten ceramics. The receptor 2, channel 5 and container 6 and heating coil(s) 4 are insulated with a layer of insulation 8 of appropriate thickness and suitable for the temperature to which it is exposed.

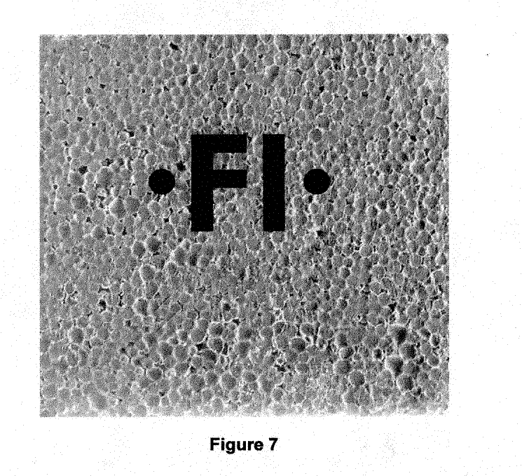

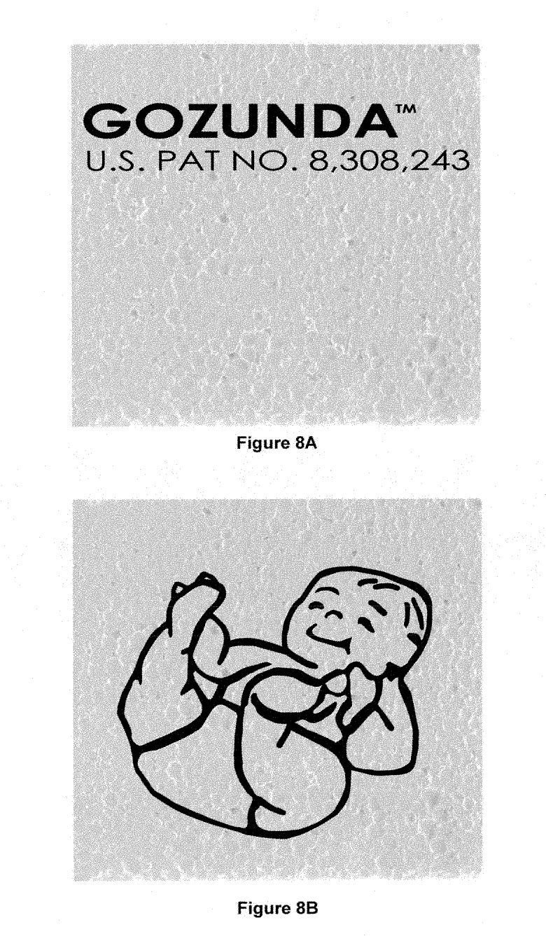

The vessel 1 shown in FIG. 6A can also be used with or without the heating coil 4 activated for at least partially filling a grooved mark made by a branding tool, a hot wire, rod or other shaped marking tool or a laser with a contrasting material like paint, various caulk type materials, silicon rubber and similar suitable material in embodiments described below for making a mark comprising one or more grooves. Also, the marking tools described below in FIGS. 7-8B for making a grooved mark can be mounted in front of the vessel 1 in such a manner like that shown in FIG. 6B that as the marking tools 14/15 attached with a bracket 12 to a frame (not shown) that holds the vessel 1 and is attached to the X-Y or X-Y-Z positioner are making a desired mark in one foam product 11, the vessel 1 is at least partially filling at least some of the grooves, in a product 11A that was just marked, with paint, various caulk type materials, silicon rubber or similar suitable material as just described above. When it is desired to simply paint at least some of the surfaces of the grooves of the mark instead of at least partially filling the grooves with a filling material then a painting nozzle controlled according to a program like or similar to that used to make the mark is mounted on an X-Y or X-Y-Z positioner to accomplish this embodiment. Also, in any of these embodiments described in FIG. 6A or 6B, the vessel 1 can be replaced with an ink jet printer, or equivalent or similar printer mounted either in front of the laser or following any of the grooving tools, see systems (10) and (11) in the Brief Summary of the Invention above. Further, the vessel 1 can be replaced with a particle thin layer dispenser and moving means ahead of the laser(s) described in systems (8) or (9) in the Brief Summary above.

FIG. 7 shows a thermoplastic polymer foam board product marked with a hot tapered tool as shown in FIG. 7A. The grooves making the mark in FIG. 7 are about 0.25 inch (6.35 mm) deep. The tapered metal marking tool shown in FIG. 7A is a soldering tip 27 on the end 28 of a BernzOmatic® ST2200T-Trigger-Start 3-in-1 Micro Torch, but could be heated in any manner prior or during the making of a mark. Just a few of many suitable marking tools are shown in FIGS. 7B, 7C and 7D.

The marking tool shown in FIG. 7B is a tip 30 of an electrically heated soldering iron readily available from many sources including a Hakko Model #FX601-02/P having temperature adjustment available from Home Depot and Hakko Model FX-600 available from Hakko, and Westward's 4Uzz9 adjustable temperature soldering kit and other sources such as Zoro's website. Many shapes of hot tips heated in any manner that controls the temperature such that the TPPFP product surface is quickly melted sufficiently to create the desired groove depth for the mark are suitable for the present invention.

FIG. 7C is a partial plan view of a torch 32, or any other source of hot air/gas at the required temperature for marking the TPPFP product, having a tube extension 33 for containing and directing hot products of combustion 39 to the surface of the product to be marked and moved, and at appropriate times lifted and lowered, to make the desired mark. Instead of a flame for producing the hot gas, air or other gas can be passed through or over an electrically heated element before passing through the tube 33. An optional extension tube 31 can be used to feed the fuel gas to the torch close to the tube 33 to prevent premature combustion when air is supplied inside torch 32 in place of fuel gas.

FIG. 7D shows an end of a torch 34 containing a combustible gas 35 and having one or more holes 36 in its lower portion for air to enter to produce a carefully controlled shape flame 37 that contacts or nearly contacts the surface of the product to be marked. The flame 37 forms a melted grove, hole, or other shaped depression in the foam product as it is moved horizontally and/or up and down. With all of these marking tools it is preferred that they be supported by an X-Y or X-Y-Z positioner that can be programmed to move and manipulate either the marking tool or the product to be marked at the correct speed and position to produce the desired mark, all of the latter being within the ordinary skill of the art.

FIG. 1 shows the two holes or dots of the mark shown FIG. 5A, the latter having their insides painted with a contrasting white paint. FIG. 5A has a vertical letter or number filled or almost filled with a white caulk material. The apparatus shown in FIG. 6A can be used, with or without using the heating element to some degree, and preferably mounted on an X-Y or X-Y-Z positioner, to fill all or part of the mark with the desired material. As shown in FIG. 6B, any tool 14/15 can be used to form the mark can be mounted in front of the filler nozzle 10 an appropriate distance on an X-Y-Z positioner to mark and fill the mark in the same cycle.

Just a few of suitable filler materials for partially, fully or over-filling the grooves, holes, etc. in the TPPFP products to give further contrast and enhancement of the mark include latex paints, flexible paints, preferably quick drying, Quickcrete® polyurethane Self-Leveling Sealant and acrylic Self-Leveling Sealant, and Quickcrete® mortar repair, concrete repair products, siliconized acrylic colored caulks called Bonsai manufactured by Color Fast Tile and Grout Caulk, WEATHERMASTER SEALANT (polyether and available in many colors, ASi 502 Silicone Sealant RTV Translucent Colors, Sikaflex 1a construction sealant manufactured by Sika Mexicana, SA, in Mexico, flexible waxes and thermoplastics of various types including the type used to make the grooves while also filling them, but heated to a temperature that will not significantly further melt the foam surface inside of the grooves. Many other filler materials can be used that are similar to these materials and also substantially different, but preferably are materials that will have a significant degree of flexibility upon drying, setting up and aging so as not to break up or chip easily with age and use.

Many of the marks made and shown in the figures identified above were made by hand and thus are not optimum in shape and uniformity, but can be made so with the marking tools or hot liquid application and the painting and/or groove filling devices moved with a programmed X-Y or X-Y-Z positioning machine and with the temperature of the branding tools and the hot liquid controlled within an optimum range, all of which is within the ordinary skill of the art and will depend upon the type of TPPFP being marked and the type of groove filling material.

Any of the branding tools, hot wires or rods or other hot melting tools including lasers, flames, hot gas tubes and other marking, painting or filling tools disclosed herein can be used to form the most precise marks by either mounting them on X-Y or X-Y-Z positioners or by keeping them in place and moving the TPPFP product with an X-Y or X-Y-Z positioner programmed to provide the desired mark. Some suppliers of X-Y and/or X-Y-Z positioners include Newmark Systems, Inc. of Rancho Santa Margarita, Calif., Zaber Technologies, Inc. of Vancouver, BC, Canada and HIS Engineering 360 website. It is well known how to set up such equipment and controlling programs to produce the desired mark. It is also within the ordinary skill of the art to determine the best temperature for the marking tools, the speed of movement of the tools, the positioning of the marking tools with respect to the surface of the TPPFP products, the depth of the mark to achieve the desired appearance, the appropriate painting materials or grove filling materials to achieve the desired appearance of the marks.

FIG. 8 shows in perspective view a mark containing letters and numbers made using a laser mounted on an X-Y positioner described below. FIG. 8A shows in perspective view a mark containing letters and numbers made using a laser mounted on the X-Y positioner. FIG. 8B shows in perspective view a mark containing a logo made using a laser mounted on the X-Y positioner. The method(s) utilizing a laser producing the markings shown in FIGS. 8, 8A and 8B are described as follows. A thermoplastic foam board product to be marked was positioned below an X-Y positioner, on which a laser was mounted, and secured in any suitable manner to prevent movement of the foam board product during the marking process.

The laser unit was a fixed CO2 laser tube that emitted a laser beam that was reflected through a series of mirrors, some of which were movable to allow transmission of the laser beam to the desired location relative to the surface of the product being marked. The mirror through which the beam ultimately passed before contacting the surface of the foam product to be rastered, marked, engraved or labeled was moved horizontally and longitudinally in the same manner similar to an inkjet printer head in a common office inkjet printer. The beam was focused through a lens such that the beam contacted the foam board surface on or below said surface at the desired depth of the groove(s) of the mark, indentation or void. The desired “Z” (vertical) axis positioning was achieved by adjusting the level on which the foam board was placed relative to the mirror/lens unit focusing the laser beam through the lens, or adjusting the height of the mirror/lens unit focusing the laser beam through the lens, or adjusting the height of the mirror/lens unit relative to the surface of the foam board such as by mounting the laser on an X-Y-Z positioner. This can, in another embodiment, involve an X-Y positioner coordinating with movement of what is commonly referred to as a “Z” table (the surface on which the foam board product is mounted).

The pattern, design or indicia imparted to the foam board product was created in a commonly available illustration/design/photo manipulation software program, such as Adobe Illustrator, Adobe Photoshop, Corel Draw, etc. The desired art was then saved as a bitmapped or vector based image depending upon the nature of the image. Alternatively, said desired mark can be simply scanned from a hard copy (printed) image and the file saved as a bitmapped file in a format such as JPEG of BMP. Vector based images permit both rastering, engraving as well as vectoring (cutting) laser functions, whereas bit-mapped based imaged permit only laser rastering. Vector based images are also fully-scaleable without a decrease in detail—unlike bit-mapped images which do not enlarge without a decrease in resolution. The saved art file is then sent to the laser in the same manner as art to be printed on a piece of paper would be sent. The ability to send files to rastered, marked or vector cut by the laser is an increasingly common feature found on commercially available lasers such as the H-Series 20×12 CO2 laser made by Full Spectrum Lasers (FSL) of Las Vegas, Nev. Other suitable commercially available CO2 lasers, such as those made by FSL, Boss Laser of Sanford, Fla., Epilog and Universal are also suitable.

Once the relative height or distance between the focusing lens and foam product surface has been set, the placement of the foam product in relation to the X and Y axes of the laser unit must be confirmed. This is accomplished by establishing and verifying that the start point on the foam product corresponds to the starting point where the laser will first contact the foam product. The depth of the groove(s), hole(s), indent(s) or void(s) to be created with the laser melting the foam can be determined by the following factors:

a) varying the percentage of the laser tube's total power or intensity. The minimum strength recommended is a 30 watt CO2 laser tube. Stronger laser tubes can be used, but depending on the type of foam being marked, the power may need to be “dialed down” to avoid burning completely through the foam or the first pass, or “dialed up” to obtain the desired depth of the mark.
b) The number of passes the laser head makes over the area of the product being marked.
c) The speed of movement that the laser head or laser beam makes over the area being marked. How fast or slow the laser beam is moved over the area being marked will determine the duration that the laser beam is focused on any given area, thus how long it is subject to the melting action of the beam.
d) Whether the area being marked is rastered, engraved, vectored, or a combination of both.

Some experimentation may be required to arrive at an optimal combination of the factors listed above to achieve the desired mark(s). The nature of the foam of the product, its density, the melting point of the foam material, nature of the art being used for the mark in the foam and strength of the laser will all impact the speed of the marking process and the mark's final appearance. Varying these factors can result in extremely subtle marking with grooves or indentations of less than 0.01 mm deep to complete vaporization of the foam material resulting in holes or channels extending from the top of the foam surface straight through to the bottom, depending upon the thickness of the product, or as deep as desired within reason. By varying the factors listed above, the edges inside the grooves, channels and/or indentations created by the laser beam can be made smooth and the foam itself annealed creating a smooth, even finish if so desired.

Because the laser beam often vaporizes part of the foam material it is important to vent the fumes created by the process out of the work area, or preferably capture them in an activated carbon filter, to prevent the operator and others from breathing in potentially hazardous fumes. Commercial lasers provide a small jet of compressed air to be blown onto the area being hit by the laser to prevent fires and blow away any debris. It is important for safety and health to be sure that this air stream is fully functioning while the laser is working. Since the air stream is generally not varied, it is considered a constant in determining the correct mix of variables that produce the desired groove(s), indentation(s) and/or void(s) created by the laser. Also, standard safety precautions are recommended such as wearing appropriate eye protection, not operating the laser with the safety shield up, and never leaving the laser unattended while operating. For best practice the laser operator should have a CO2 fire extinguisher in good order on hand in the event of a fire.

The laser made grooves making the logo mark shown in FIG. 8B are about 0.07 inch (1.8 mm) deep and the depth of the grooves making up the mark in FIG. 8 are about 0.15-0.16 inch (about 4 mm) deep.

The method utilizing a laser produced the markings shown in FIGS. 8, 8A and 8b and was undertaken in the following manner.

1) In the case of the text “GOZUNDA™” as shown in FIG. 8, the desired image was created in Adobe Photoshop® 7.0 using the ARIAL font. The font size was 72 points, regular type, with standard kerning, at 100% the desired size. The image was saved as a JPEG file. In the case of the baby image as shown in FIG. 8B, the desired image art was originally imported from a clip art file into Adobe Photoshop 7.0. The clip art was sized to 100% of the desired output size and saved as a JPEG file.
2) In creating both the laser engraved foam surface shown in FIG. 8, with the GOZUNDA™ text, and FIG. 8B, with the baby image, the JPEG images were imported into COREL DRAW HOME® & STUDENT X6®. The files were imported onto newly created pages 20″ wide×12″ tall (which is the working area of the Full Spectrum H-Series). Once imported the JPEG is converted to a vector based file using the “trace bitmap” function in COREL DRAW®. In the ‘trace-bitmap” the “Outline Trace” option is preferred as is the “High Quality image” option. In this option allows the detail and smoothness of the image to be adjusted before the file is converted to a vector-based file. The settings used for both the GOZUNDA™ and baby image or logo were maximum detail, and a “smoothing” setting of 50. The “corner smoothing” setting was left at “0”. By hitting the “OK” button the file is then transformed from a JPEG to a vector based file by COREL DRAW®.
3) The Full Spectrum Laser H-Series 20×12 laser comes with Retina Engrave® software, which allows a COREL DRAW® file to be sent to the H-Series laser simply by choosing the laser as an output “printer”. Once the “Full Spectrum Engineering Driver” is chosen as the filed output device, the following settings must be put in place:
a) Landscape orientation layout.
b) Under “Preferences” tab on the right
Layout
Landscape
   and then click
Advanced
Paper Output, Paper Size: FSL Hobby Series Gen5 20×12
OK
OK

### c) Under “Layout” tab at the top

Reposition images to: Top left corner (so the starting point of the laser will correspond to the top left part of the image to be put into the foam board).
   . . . Then once everything looks correctly laid out in the window to the right of the settings box,
   4) Once these settings are put in place hit the “Print” button, which sends the file to the Retina Engrave® software, which controls the laser itself. At this point the file to be printed will begin to appear in the Full Spectrum Retina Engrave® program (FSLRE). Before processing the file the FSLRE may display a window titled “Large Raster Job”. This window will tell the FSLRE whether to process the file for both raster (engraving rows of small dots) and vector (cutting continuous lines) cuts. Since only the raster function is required to impart the desired image(s) to the foam board, select:
YES: Continue loading large raster (which will convert the image to a bitmap)
   5) The image has now been processed by the FSLRE and ready to be imparted to the foam board in a method referred to as rastering. Essentially this means that the laser will shoot a series of small dots onto the board surface, which will melt the foam and create an impression. Before starting the rastering, the operator must:
   a) be sure that the laser unit is connected to an electrical power source and turned on.
   b) be sure that the laser unit it connected to the computer with the FSLRE via DSL cable.
   c) position the foam board such that the area to be initially engraved (rastered) corresponds to the position of the laser head. Both of these points should be in the upper left area of the image and laser working space. The foam board should be secured to prevent any movement or shifting while the laser is operating.
   d) The Z (vertical) axis of the laser head unit should be set at the optimal distance for the laser unit lens. This is achieved by positioning the laser head unit at the distance provided using the set focal length reference tool that comes with the H-Series laser (in this case a cylindrical aluminum piece). This ensures that the laser beam will hit the foam surface at the most effective distance.
   e) The air nozzle in the laser head unit should be emitting a stream of air at about 30 psi, the water cooler must be on, and a vacuum system must vent the fumes from the laser to the outside air, or preferably through an activated carbon filter—which will capture most fumes created by the burning and vaporization of the foam.
   6) In the FSLRE the rastering process can be controlled by setting the following variables:
   a) Raster power: A setting of 25% of the H-Series 30 watt laser tube was found to be optimal.
   b) Raster speed: A setting of 50% of the H-Series laser was found to be optimal.
   c) Passes: One pass was found to be optimal.

### Note:

B/W Threshold was is not a factor in this process and can be left at the default setting of 165.
The speed, deepness and sharpness of the engraving (rastering) can be altered by the combination of Raster Power, Raster Speed, and number of passes. Trial and error will provide the best information as to what combination of settings is optimal for a given image and material to be rastered, marked. Too much power, too many passes and slower speed may or will result in deeper impressions, burning clear through the material, or even causing fire. Therefore, the laser unit should never be left unattended while in operation, and a CO2 fire extinguisher should be on hand at all times.
   7) With the Raster Power, Raster Speed, and number of passes set, the raster process can be started. The clear plastic safety shield must be lowered at this point. Be sure that the function at the top of the FSLRE reads: “Raster Mode” and then hit the green right-pointing arrowhead at the top of the FSLRE screen. The program will display the time required for the rastering in the lower right as “Estimated Job”. It is important NOT to move or bump the laser or the foam board during the rastering process as this may cause an error in the image.
   8) Once the rastering process is over visually inspect the laser head through the clear plastic safety shield and make sure that the laser is not working and that the laser tube in the back is not emitting any colors (which means it is still on). Return the laser head unit to the HOME position (in the upper right of the laser work area), and only then open the safety shield and remove or reposition the foam board.

The following is a brief list of considerations common to imparting an image using laser rastering, marking:

a) The pattern, design or indicia, logo, etc. to be imparted to the foam may be created not only in Adobe Photoshop®, but also in a commonly available illustration/design/photo manipulation software programs such as Adobe Illustrator,® Corel Draw®, etc. Alternatively, said pattern, design or indicia can be simply scanned from a hard copy (printed) image and the file saved as a bit-mapped file in a format such as JPEG of BMP, and then imported into COREL DRAW® to be translated into vector based files.
b) Vector based images permit both rastering (engraving, marking, etc.) as well as vectoring (cutting) laser functions, whereas bit-mapped based imaged permit only laser rastering. Vector based images are also fully-scaleable without a decrease in detail, unlike bit-mapped images which do not enlarge without a decrease in resolution.
c) The ability to send files to be rastered or vector cut by the laser directly is an increasingly common feature found on commercially available lasers such as the H-Series 20×12 CO2 laser made by Full Spectrum Lasers® (FSL) of Las Vegas, Nev. Other suitable commercially available CO2 lasers, such as those made by FSL, Boss Laser® of Sanford, Fla., Epilog® and Universal®.
d) The laser unit consists of a fixed CO2 laser tube that emits a laser beam that is reflected through a series of mirrors, some of which are moveable to allow transmission of the laser beam to the desired location relative to the surface being processed. The mirror through which the beam ultimately passes before contacting the surface to be rastered or cut is moved horizontally and longitudinally in the same manner similar to an inkjet printer head in a common office inkjet printer. The beam is focused through a lens such that the beam contacts the foam surface on or below said surface at the desired depth of the groove, indentation or void. The unit that holds the last mirror, the lens and the opening of the low-pressure air hose is called the laser head unit. The optimal distance between the laser head unit and the surface to be worked on is set using a set focal length reference tool, which comes with the laser.

The laser made grooves making the logo mark shown in FIG. 8B are about 0.07 inch (1.8 mm) deep and the depth of the grooves making up the mark in FIG. 8 are about 0.15-0.16 inch (about 4 mm) deep.

Instead of mounting one or more lasers on an X-Y or X-Y-Z positioner to move the laser(s) to form the mark it is also known to avoid an X-Y positioner and in some instances either the Z positioner and instead use one or more mirrors, usually movable in ways including the angle of reflector, by rotation or movement in the X, Y, and/or Z direction, to direct one or more laser beams to make the mark in a much faster manner than using an X-Y positioner. These systems are well known and are mentioned and/or cited and/or described in U.S. Pat. Nos. 5,786,594, 6,313,433, 6,423,925, 7,060,934, 8,101,883, 8,294,062, and 8,599,898, and also U.S. Published Application No. 20150183231, the disclosures of which, including the prior art and the patents cited therein, are hereby incorporated herein by reference. At least some of these systems are available from Universal Laser Systems® Inc. of Scottsdale, Ariz.

Different embodiments employing the concept and teachings of the invention will be apparent and obvious to those of ordinary skill in this art and these embodiments are likewise intended to be within the scope of the claims. Just one example of this is to use a robot or other positioning device to position the various systems disclosed above in the manner or similar manner described to achieve the disclosed results. The inventor does not intend to abandon any disclosed inventions that are reasonably disclosed, but do not appear to be literally claimed below, but rather intends those embodiments to be included in the broad claims either literally or as equivalents to the embodiments that are literally included.

1. A system comprising a device or devices for hot marking one or more letters and/or words and/or numbers and/or logos and/or symbols and/or pictures and/or grooves and/or valleys and/or holes and/or depressions to form a desired pattern into and below a surface, a surface portion, of a foam product by vaporizing and/or melting the desired pattern in the surface, surface portion of the foam product, the foam product comprising about 10 to about 99 percent of voids or gas bubbles therein.

2. The system of claim 1 wherein the marking device is selected from a group consisting of a hot branding iron, a hot tool capable of moving through a surface portion of the foam product, a flame, a hot liquid and a laser, hot meaning a temperature above the melting point of the surface portion of the foam product.

3. The system of claim 1 wherein the system also includes an X-Y or X-Y-Z positioning device, or both positioning devices, to move the marking device in a desired pattern to mark the foam product.

4. The system of claim 1 wherein the system also includes a device holding a liquid, the device being movable to fill the desired pattern with the liquid, the liquid upon drying and/or curing being of a contrasting color to the foam product.

5. The system of claim 1 wherein the marking device is a laser.

6. The system of claim 2 wherein the marking device is a laser and wherein at least a part of the foam surface portion marked is vaporized.

7. The system of claim 3 wherein the marking device is a laser.

8. The system of claim 4 wherein the marking device is a laser.

9. The system of claim 1 wherein the foam product comprises polymer foam.

10. The system of claim 2 wherein the foam product comprises polymer foam.

11. The system of claim 3 wherein the foam product comprises polymer foam.

12. The system of claim 4 wherein the foam product comprises polymer foam.

13. The system of claim 5 wherein the foam product comprises polymer foam.

14. The system of claim 6 wherein the foam product comprises polymer foam.

15. The system of claim 7 wherein the foam product comprises polymer foam.

16. The system of claim 8 wherein the foam product comprises polymer foam.

17. A foam product comprising a void and/or gas bubble content of about 10 to about 99 volume percent marked with a desired pattern on and below a surface of the foam product, the pattern having at least traces of a melt of the foam on at least parts of the surface of the pattern.

18. The foam product of claim 17 wherein the foam comprises one or more of a polymer and/or a resin and/or a glass and/or a metal and/or a ceramic material.

19. The foam product of claim 17 wherein the foam is a polymer.

20. A method of marking a foam product having a void and/or gas bubble content of from about 10 to about 99 volume percent, the method comprising the steps of vaporizing and/or melting one or more letters and/or words and/or numbers and/or logos and/or symbols and/or pictures and/or grooves and/or valleys and/or holes to form a desired pattern in a surface portion of the foam product using one or more of;
a) a branding iron wherein the raised portions forming the letters and/or words and/or numbers and/or logos and/or symbols and/or pictures and/or grooves and/or valleys and/or holes to form a desired pattern have a temperature at least high enough to melt the foam product when the hot branding iron is pressed into the surface of the foam product, or
b) a rod or wire having a temperature at least high enough to melt the foam product and a device to move the hot rod or hot wire in a manner to form the desired pattern in a surface portion of the foamed product, or
c) a small, controlled flame having a temperature at least high enough to melt the foam product moved by a device in a manner to form the desired pattern in a surface portion of the foamed product, or
d) A flow of hot gas moving through an open ended tube, the hot gas exiting the tube and striking a surface of the foam product having a temperature at least high enough to melt the foam product and a device to move the open ended tube in a manner to form the desired pattern in a surface portion of the foamed product, or
e) a container containing a hot liquid, the container having a nozzle forming a small stream of the hot liquid onto a surface of the foam product, the hot liquid having a temperature high enough to at least melt a surface portion of the foam product and a device to move the nozzle in a manner to form the desired pattern in a surface portion of the foamed product, or
f) a laser and a device to move the laser in a manner to form the desired pattern in a surface portion of the foamed product, and optionally a
g) a container having a nozzle, the a plastic or liquid material of contrasting color to the surface portion of the foam product in the container, the plastic or liquid capable of flowing through the nozzle when the nozzle is opened and a device to move the nozzle in a manner to at least partially fill the grooves and/or holes forming the desired pattern in the surface portion of the foamed product.
